(19) United States
(12) Patent Application Publication
(10) Pub. No.: US 2010/0263398 A1
(43) Pub. Date: Oct. 21, 2010

(54) COOLER SOUND SYSTEM

(76) Inventor: Jeff Webb, Denham Springs, LA (US)

Correspondence Address: ROY KIESEL, a PLC, 2355 DRUSILLA LANE, BATON ROUGE, LA, 70809, US

(21) Appl. No.: 12/427,092

(22) Filed: Apr. 21, 2009

(51) Int. Cl. F25D 9/00; H04R 1/02

(52) U.S. Cl. 62/331; 381/386

(57) ABSTRACT

A cooler with installed audio equipment is disclosed. The cooler is divided into two distinct and watertight compartments. One compartment is for traditional cooler use, for example, with iced beverages. This compartment may be wet, and has an internal drain to facilitate removal of water or other liquids. A second compartment is provided for audio equipment including speakers and an amplifier. A removable power supply also may be housed in the second compartment. The audio equipment may be supplied with an audio signal for a portable device, such as an mp3 player. The cooler is fitted with dual lids, one for each compartment. The cooler compartment lid may be opened while the audio equipment compartment lid remains closed, thus protecting the audio equipment from potentially damaging liquid. Conversely, the audio equipment compartment lid may be opened as desired without introducing warm air into the cooler compartment. The resulting device provides a portable cooler capable of producing high-end audio.

### BACKGROUND

Recreation takes many forms. When groups recreate, it is common to bring a cooler (sometimes called an ice chest) along with iced beverages or other items. It is also common to bring some type of audio device capable of providing music. Trips to the beach, outings on boats, tailgating prior to sports events, and picnics are just a few examples of situations where it is often desirable to have both a cooler with iced items and an audio device.

Traditionally, satisfying this desire required bringing two separate items on the outing. A trip to the beach, for example, might include one person bringing a cooler and another person bringing a portable stereo. It is not surprising that some persons have tried to combine these two items into a single device. Those efforts have not been entirely satisfactory.

Some efforts along these lines have involved installing a full, portable stereo device into the lid or some other part of a cooler. The stereo devices used typically were the same kind of portable stereos usually carried by persons. These devices are somewhat large, with many models being comparable in size to a cooler. It clearly was not feasible to combine a large, portable stereo device with a cooler of about the same size. Doing so would leave little or no space left in the cooler.

A different approach to this challenge has been tried by some. Rather than trying to install a portable, full-function, stereo device into a cooler, some persons have instead used audio components similar to those used in vehicles. Car audio speakers have been installed in holes cut into the sides of coolers, and various audio components have been placed inside the cooler to power the speakers. These systems provide quality audio, but use a relatively large amount of power, thus requiring either a power source or a large battery. In addition, these systems tended to convert the entire cooler into an audio device, with the audio equipment using the full space in the cooler. This approach, therefore, results in the replacement of one type of portable audio device (e.g., a portable stereo) with another (a cooler retrofitted with car audio equipment).

The reason this approach fails to combine an audio device and a cooler is that the installed audio equipment must be isolated from water. When car audio devices, including speakers, are installed inside the cooler, it is no longer possible to use the cooler to ice beverages or other items. The water resulting from melting ice would damage or destroy the audio equipment.

One known device uses a divider to form two separate compartments within a cooler. This device is disclosed in U.S. Pat. No. 7,188,491 to Donald II, et al. The device disclosed in the Donald patent, however, suffers from the same problems noted above, because the device installs speakers in both compartments. This arrangement results in speakers in the cooler compartment. The speakers and the wiring for those speakers are either exposed to potentially damaging water or must somehow be sealed. Sealing the back area of an audio speaker can materially alter its performance and greatly reduce the quality of the audio it produces. Moreover, the back area of the speaker, even if sealed, may be subject to physical damage from beverage cans, ice, or other items in the cooler compartment.

The Donald device is different in another respect, too. It is a multi-media apparatus, capable of providing audio and video to users. It requires a number of audio and video components installed in the cooler. This results is substantial weight. A multi-media system also may draw considerable power, which would require a larger capacity power source to provide a desirable use period (e.g., at least a few hours). Portable power typically means lead-acid batteries, which are heavy. The more or larger the batteries are, the heavier they are.

What is needed is a device that combines the best of both worlds. Such a device would include a reasonably-sized cooler compartment that is fully sealed and separated from an audio equipment compartment. Dual lids or covers would allow one compartment to be accessed while keeping the other compartment closed. This feature would help protect the audio equipment from water, and also help keep the cooler compartment cool. The audio equipment would be relatively small (e.g., compared to a fall suite of audio and video equipment), and the audio source could be a personal audio player like an mp3 player or a portable satellite radio receiver. It also would be desirable to minimize the power consumption so that a relatively small, portable power supply could be used.

The present invention meets these needs. In a preferred embodiment, the invention includes a portable cooler having a cooler compartment and an audio equipment compartment. A separate lid is provided for each compartment. An amplifier, power supply, and speakers are positioned in the audio equipment compartment. The amplifier has an audio input line for connection to an audio source, such as a personal audio device like an mp3 player or radio. This configuration results in only the required electronic equipment, thus reducing the space required and the power consumed. The invention thus provides a truly portable cooler with high-quality audio. Additional features and characteristics of the preferred embodiments of the present invention will be described in more detail below.

### BRIEF DESCRIPTION OF THE DRAWINGS

FIG. 1 is a front schematic view of a preferred embodiment of the present invention.

FIG. 2 is an end schematic view of a preferred embodiment of the present invention.

FIG. 3 is a schematic view of the opposite end from that shown in FIG. 2.

FIG. 4 is a top view of a preferred embodiment of the present invention, shown with both lids open so the internal parts are visible.

FIG. 5 is a top view of a preferred embodiment of the present invention, shown with both lids closed so the top of the lids are visible.

### DETAILED DESCRIPTION OF THE PREFERRED EMBODIMENTS

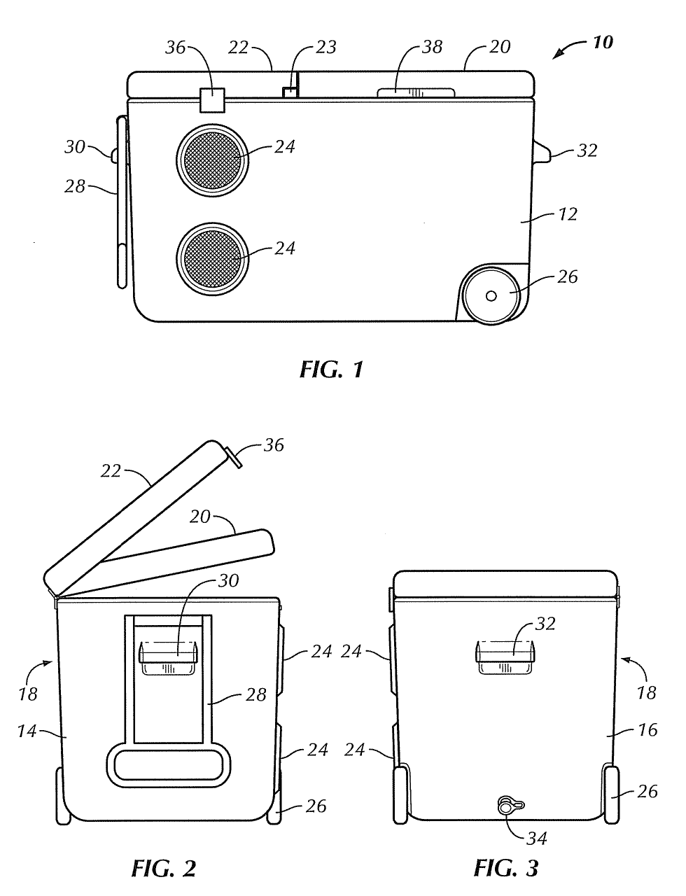

FIGS. 1-5 illustrate the key components of a preferred embodiment of the present invention. In FIG. 1, a front view is provided of a cooler 10 with a front wall 12. The cooler has two internal compartments (not shown in FIG. 1), and each compartment has its own lid. The cooler compartment lid 20 is positioned over the cooler compartment, and the audio equipment compartment lid 22 is positioned over the audio equipment compartment. A notch 23 in the audio equipment compartment lid 22 is provided that mates with a divider wall (shown in later figures). A pair of speakers 24 are mounted in the front wall 12, so that the rear portions of the speakers are located within the audio equipment compartment.

The cooler 10 has a pair of wheels 26 and a large swing handle 28, which is rotated upward to lift one end of the cooler 10. When so lifted, the cooler 10 rolls on the wheels 26. The cooler compartment in the preferred embodiment is located on the end of the cooler 10 with the wheels 26. When the cooler compartment is filled with ice and other items, it probably will be heavier than the audio equipment compartment. Positioning the cooler compartment near the wheels means the compartment need not be lifted much to enable the cooler 10 to roll. This males it easier to transport a filled cooler 10. A drain hole is also placed in the cooler 10 on the end with the wheels 26, which facilitates easy draining, particularly when the cooler 10 is being transported. The cooler 10 is tilted for transport, which aids in draining. This is another reason to place the cooler compartment on the end with the wheels 26. Despite these preferences, the invention contemplates a cooler compartment on either end of the cooler 10, as this aspect of the design is not critical to the benefits of the present invention.

The cooler 10 shown in FIG. 1 also has a first lifting handle 30 on the end with the swing handle 28, and a second lifting handle 32 on the end with the wheels 26. These lifting handles allows the entire cooler to be lifted or lowered. The cooler compartment lid 20 has a latch/grip 38 and the audio equipment compartment lid 22 has a latch 36. No particular preference exists for the latches for the two lids. FIG. 1 illustrates two common types of latches found on coolers. The cooler compartment latch/grip 38 shown in FIG. 1 is a cut-out type of grip, with the lid having an internal lip or ridge that engages the inside of the cooler walls by a friction fit. The audio equipment compartment latch 36 is a snap-type latch. Either type may be used, or other types of latches may be used. For example, a lockable clasp may be used for the audio equipment compartment to provide the ability to lock that part of the cooler shut, and thus reduce the threat to theft.

The two lids are connected to cooler using standard connecting hardware. For example, a long hinge may be used or a number of smaller hinges may be used. Some hinge-like connector is needed to allow the lids to open and shut.

FIGS. 2 and 3 show the two end views of a preferred embodiment of the invention. In FIG. 2, the end having the large swing handle 28 is shown. Lifting handle 30 is also shown. The audio equipment compartment end wall 14 is seen in this figure. The dual lids are shown at different stages of opening, to highlight that each lid is a distinct part of the device. The audio equipment compartment lid 22, with its latch 36, is shown about 50% open. The cooler compartment lid 20 is shown about 20% open. The wheels 26 can be seen in profile, as can the front part of the speakers 24. The back wall 18 forms the back side of the cooler 10.

FIG. 3 shows the cooler from the opposite end. In this illustration, the lids are both shut. The cooler compartment end wall 16 is shown, with the lifting handle 32 located on that wall. Back wall 18 is also identified. The wheels 26 are shown, as well. Finally, a drain plug 34 is shown covering a drain hole in the cooler compartment.

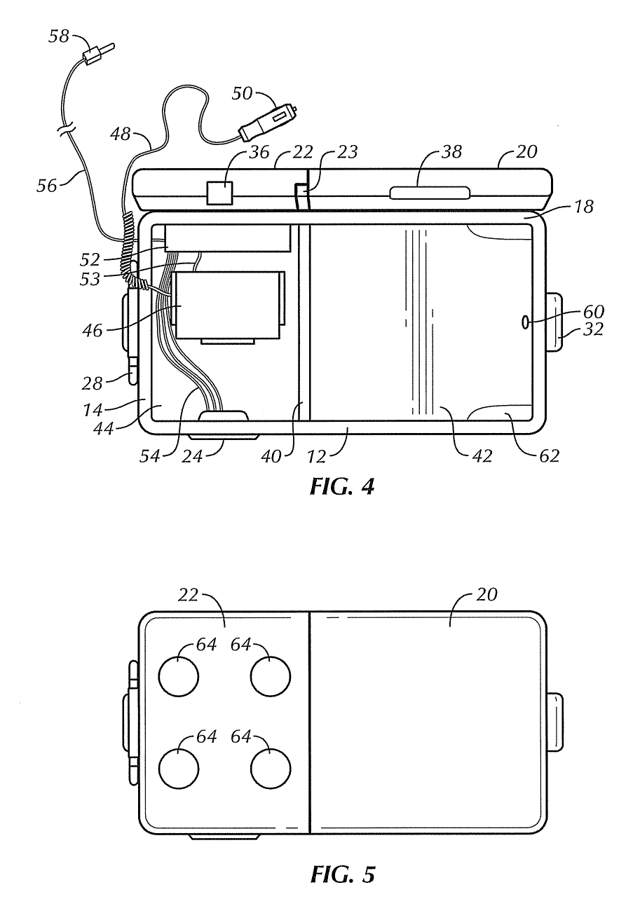

Turning to FIG. 4, a number of key aspects of the invention are shown. The cooler compartment 42 and the audio equipment compartment 44 are shown, with a divider wall 40 separating these two compartments. The divider wall 40 is a watertight wall sealed to the interior of the front wall 12, the back wall 18 and the bottom of the cooler 10. The top edge of the divider wall 40 is not permanently sealed to any other component. Instead, the top edge of divider wall 40 engages the notch 23 in the audio equipment compartment lid 22, and thus forms a seal when the lid is closed. There is no preference for this arrangement, and the notch 23 could be in the cooler compartment lid 20. Alternatively, both lids could have smaller notches to fit the thickness of the divider wall 40.

The drain hole 60 is shown inside the cooler compartment 42. Water or other liquids in the cooler compartment may be drained through this hole 60. As explained above, such draining is facilitated by lifting the opposite end of the cooler 10. Internal wheel housings are also shown in the cooler compartment 42.

The audio equipment compartment 40 contains some of the key components of the invention. The speakers 24 are installed in the audio equipment compartment 44. Speakers are mounted only in the front wall 12 in this embodiment, but additional speakers could be installed in the audio end wall 14 of on the back wall 18, so long as any back wall speakers were positioned within the audio equipment compartment 44. This is an important characteristic of the present invention. Locating the speakers 24 within the audio equipment compartment ensures the speakers 24 and the speaker wires 54 remain dry. It also allows for replacement (e.g., to upgrade or to replace a damaged speaker) of speakers even while the cooler compartment is filled with iced beverages.

An amplifier 52 is shown mounted on the back wall 18 of the audio equipment compartment 44. This is preferred, but the amplifier 52 could be mounted to any surface within the audio equipment compartment 44, including on the divider wall 40. If the amplifier 52, or any other component, is mounted on the divider wall 40, it may be necessary to apply sealant to the mounting holes to ensure the divider wall 40 remains a watertight separation between the two compartments. It also is preferred to permanently mount the amplifier 52 within the audio equipment compartment, though non-permanent installation is also contemplated.

The amplifier 52 has at least three sets of electrical connections. It has a power line 53 that provides an appropriate power source to the amplifier 52. In the preferred embodiment, this is a 12V DC power supply line. The supply may be fused to protect the amplifier 52 and speakers 24. Second, the amplifier 52 has speaker wires 54 that extend from the amplifier 52 to the speakers 24. An input source line 56 extends from the amplifier 52, and is connected to an appropriate audio source. A mini-headphone jack 58 is shown at the end of the input source line 56 in the preferred embodiment. This jack 58 may be connected to a personal audio device like an mp3 player or a radio, including a satellite radio.

The audio sources expected to be used with the present invention are small and use little power. For example, an iPod® Nano® mp3 player is about the size of a credit card and has a play time of several hours on a charge. Such a device could be connected to the invention via the mini-headphone jack 58 and supply audio for several hours. The small personal audio devices of this type could be placed inside the audio equipment compartment 44 for security reasons, or could be placed in a cup holder or other insert in the audio equipment compartment lid 22. The latter option would leave the audio source available to users, which may be desirable to allow for easy selection of particular music choices.

The amplifier 52 in the preferred embodiment is powered by a portable power supply 46. In the most preferred embodiment, the power supply 46 is a portable jump-start battery, of a kind readily available from discount stores and auto parts stores. These batteries are 12V DC lead-acid batteries, but are typically much smaller than a full-size vehicle battery. This type of power supply is preferred because they are readily available, relatively small, and designed for easy charging. A battery of this type, when used with the preferred embodiment described herein, will power the invention for several hours of use. This arrangement provides a truly portable cooler with high-end audio that may be enjoyed for several hours. Some models of jump-start batteries have prewired lines with large electrical clamps on the end, for ease of connecting to a vehicle battery. Such lines are removed before use in the present invention, and the positive and negative contacts of the battery are connected to the appropriate power input connections of the amplifier.

It is preferred to install the power supply 46 so that it may be removed for recharging. Brackets, straps, or other means for temporarily securing the power supply 46 within the audio equipment compartment 44 may be used. A bracket sized to a particular battery is most preferred, though a strap arrangement may provide more flexibility. The power supply 46 has an output line 53 that provides power to the amplifier 52. Output line 53 represents the electrical power connection, and is likely to consist of two distinct wires in practice (i.e., a positive and negative connection). These connections are shown as a single output line 53 in the drawings for ease of illustration. The power supply 46 also has a cord 48 that may have a 12 V DC accessory plug 50, mated to typical 12 V DC receptacles found in many automobiles. The power supply 46 may be charged while installed in the cooler, or it may be removed for charging. To accomplish the former, a charging cord long enough to reach at least a few feet outside the cooler is needed.

The present invention also contemplates the use of more than one battery power supplies for extended uses. For example, if a group of persons is camping out overnight, a single battery power supply may not be sufficient to provide audio as long as desired. A second, or even third, portable jump-start type battery (i.e., a fully charged battery) may be brought and swapped out with the primary battery when that battery has depleted its charge. Holding brackets for additional power supply batteries may be provided on the top of the cooler compartment lid 20, making it easier to transport such batteries.

It is further contemplated that the power supply 46 could be used to maintain the charge of the personal audio player being used as the music source. A typical mp3 player uses very little power and could be easily recharged through the power supply 46 without causing a significant depletion of the power supply battery's charge. An appropriate adaptor may be needed for this type of use, but such adaptors are widely available for many types of personal audio players. A second power output line, or a split in the primary output line 53, could be used to supply power to an appropriate personal audio player power adapter. When this capacity is combined with the use of multiple power supply batteries, the present invention provides the potential for high-quality audio for many hours, and possibly for an outing extending over two or more days.

The power supply cord 48 and the audio input source line 56 may be installed using jacks mounted into the side of the audio equipment compartment 44. This particular type of configuration is not shown in the figures, but is well-known in the art. By using a jack mounted in the side of the cooler, no cords would have to extend between the audio equipment compartment lid 22 and the sides of the cooler 10. In other words, if no jack is used, and the portable audio device providing the audio signal to the amplifier 52 is outside the cooler, the line 56 between the portable audio device and the amplifier 52 must extend out of the cooler. When the audio compartment lid 22 is shut in such a situation, the lid 22 closes over the audio input line 56. This is not a problem, but may not be desirable to some users.

The jack configuration eliminates this concern. An input jack is installed in the audio compartment end wall 14. The jack could be installed in the front wall 12 or back wall 18, but the end wall 14 is preferred. The internal end of the jack is hard-wired to the amplifier input line. An external audio input line is then used to connect the system to the audio source. The external audio input line would have on one end a plug that fits into the input jack and on the other end, a plug that fits the output of the portable audio player. This arrangement avoids the need to run the input line 56 over the side of the cooler 10.

A jack also could be used for the power cord 48 to prevent the need to run this cord out of the cooler when the power supply is recharged. This may be less of a concern because recharging the power supply will not usually happen during use of the system. Alternatively, the power supply cord 48 and the audio input source line 56 could be installed through the wall of the cooler 10 in a more permanent fashion. Using some type of jack or quick-disconnect connection is preferred, however, as it provides more flexibility.

A standard 12V DC power receptacle, of the same type commonly found in automobiles, may also be installed in a wall of the audio equipment compartment. The end wall is again preferred. This receptacle would be powered by the portable power supply 46. Such a receptacle could be used for a variety of purposes. For example, a user with a 12V DC cell phone charger could plug the charger into the receptacle and recharge a cell phone. Many portable audio devices have 12V DC chargers, and those types of devices also could be recharged using such a receptacle. Other uses would also be possible.

FIG. 5 shows the top of the cooler 10 with both lids closed. The audio equipment compartment lid 22 is shown with four cup or can holders 64. Such holders also could be placed in the cooler compartment lid 20, but that is not preferred, because all cups or cans would have to be removed each time the cooler compartment 42 is accessed. In addition, it is likely the holders 64 will extend partially into the space of the compartment below. There will be space available in the upper part of the audio equipment compartment 44, but extending holders into the cooler compartment 42 might reduce the usable space within that compartment.

The audio equipment compartment lid 22 also may have a recess designed to accommodate popular personal audio players. In addition, such a recess might be configured to mate with adaptors so that a wider array of personal music players would fit the recess. This approach is used in other systems designed for use with the iPod® line of music players.

The audio input line 56 may be run to a plug mounted into a recess in the audio equipment compartment lid 22. A mini-headphone plug could be permanently installed at one end of a recess, so that a personal audio player output connection would engage the mini-headphone plug when the audio player is placed into the recess. The player could be securely held in the recess (perhaps using custom-sized adaptors, if necessary, like those used with other iPod® compatible systems) and be connected to the audio system in one action. By using a custom plug, rather than a standard mini-headphone plug, this arrangement could provide a unitary audio connection and a power connection to keep the audio player charged while it is being used. These features are not central to the invention, but may enhance the system and make it more attractive to some users.

While the preceding description is intended to provide an understanding of the present invention, it is to be understood that the present invention is not limited to the disclosed embodiments. To the contrary, the present invention is intended to cover modifications and variations on the structure and methods described above and all other equivalent arrangements that are within the scope and spirit of the following claims.

I claim:

1. An insulated cooler comprising:
a. a cooler compartment;
b. a cooler compartment lid connected to the cooler compartment and providing an upper surface of the cooler compartment when the cooler compartment lid is closed;
c. an audio equipment compartment located adjacent to the cooler compartment;
d. a liquid impermeable divider wall that separates the audio equipment compartment and the cooler compartment;
e. an audio equipment compartment lid connected to the audio equipment compartment and providing an upper surface of the audio equipment compartment when the audio equipment compartment lid is closed;
f. one or more speakers installed in the audio equipment compartment, such that no speakers are installed in the cooler compartment and no speaker wires extend outside the audio equipment compartment;
g. an amplifier positioned in the audio equipment compartment and electrically connected to the speakers, the amplifier having an audio input source line configured for receiving an audio signal from a portable audio device; and,
h. a portable, rechargeable power supply positioned in the audio equipment compartment and electrically connected to the amplifier to supply electrical power to the amplifier.

2. The cooler of claim 1, further comprising:
a. an audio equipment compartment end wall;
b. a handle installed in the audio equipment compartment end wall;
c. a cooler compartment end wall; and,
d. pair of external wheels mounted near the cooler compartment end wall such that the cooler may be tilted up by lifting the handle such that the cooler rests on the pair of external wheels and may be rolled on the wheels.

3. The cooler of claim 2, further comprising a drain hole in the cooler compartment end wall and a drain plug to cap the drain hole when not in use.

4. The cooler of claim 2, wherein the handle is a large swing handle configured to reach approximately to a user's waist area when the handle is swung up into a lifting position.

5. The cooler of claim 3, further comprising a first lifting handle installed in the audio equipment compartment end wall and a second lifting handle installed in the cooler compartment end wall.

6. The cooler of claim 2, wherein the liquid impermeable divider wall extends upward to a point horizontally level with an upper end of the audio equipment compartment end wall and the cooler compartment end wall, and the audio equipment compartment lid has a notch sized to fit snugly over an upper edge of the liquid impermeable divider wall.

7. The cooler of claim 1, wherein the power supply is a portable 12 volt lead-acid battery.

8. The cooler of claim 1, wherein the power supply is a portable, jump-start, automotive battery.

9. The cooler of claim 1, wherein the amplifier is permanently installed and the portable power supply is secured, but not permanently installed in the audio equipment compartment.

10. The cooler of claim 1, wherein the amplifier's audio input source line extends from the amplifier to a point outside the cooler, such that the portable audio device supplying the audio signal to the amplifier may be located outside the cooler during use.

11. The cooler of claim 10, wherein the audio compartment lid has a recessed space for holding the portable audio device during use.

12. The cooler of claim 11, wherein the portable audio device is a personal audio player.

13. The cooler of claim 11, wherein the recessed space further comprises a plug for connecting the portable audio device to the amplifier while the portable audio device is secured within the recessed space.

14. The cooler of claim 1, wherein each speaker further comprises at least a two-way speaker system.

15. The cooler of claim 1, further comprising
a. an audio input jack installed in an audio equipment compartment end wall, wherein the amplifier's audio input source line is electrically connected to an internal side of the audio input jack; and,
b. an external audio input line having a first end with a plug mated to the audio input jack and a second end having a connector appropriate for connection to the portable audio device.

16. The cooler of claim 1, wherein the portable power supply has a recharging cord capable of being extended from the cooler to a recharging source without removing the portable power supply from the audio equipment compartment of the cooler.

17. The cooler of claim 2, further comprising recessed cup holders in an upper surface of the audio equipment compartment lid.

18. The cooler of claim 1, further comprising a portable audio device power line connected to the portable power supply and the portable audio device such that the portable power supply provides electrical power to the portable audio device.

19. The cooler of claim 1, wherein a second portable power supply is provided as a back-up power source to replace the primary power supply when its power has been depleted.

20. The cooler of claim 1, wherein a 12V DC receptacle is installed in an external wall of the audio equipment compartment and is electrically connected to the portable, rechargeable power supply.

21. An insulated cooler comprising:
a. an audio equipment compartment having a front wall, a bottom, a back wall, an end wall, and an interior divider wall;
b. an audio equipment compartment lid that forms a top of the audio equipment compartment when the lid is closed;
c. a pair of audio speakers installed in the front wall of the audio equipment compartment;
d. an amplifier installed in the audio equipment compartment and operatively connected to the pair of audio speakers so that the amplifier provides an amplified audio signal to the pair of audio speakers;
e. a portable battery installed in the audio equipment compartment and electrically connected to the amplifier to provide a power source to the amplifier, and wherein all installed audio equipment is located in the audio equipment compartment of the cooler.

22. A method of creating an insulated cooler sound system comprising:
a. installing a liquid impermeable and sealed internal divider wall within the cooler so that a cooler compartment and an audio equipment compartment are formed;
b. fabricating separate lids for the cooler compartment and the audio equipment compartment;
c. replacing the standard cooler lid with the cooler compartment lid and the audio equipment compartment lid;
d. cutting a pair of holes in a front wall of the audio equipment compartment, wherein the holes are sized to fit a pair of audio speakers selected for the system;
e. installing the pair of audio speakers in the pair of holes;
f. installing an audio amplifier in the audio equipment compartment and connecting speaker wires between the output of the amplifier and the input terminals of the speakers;
g. mounting a portable power supply in the audio equipment compartment and electrically connecting the power supply to the amplifier; and,
h. connecting an input source line of the amplifier to a portable audio source.
